(19) United States
(12) Patent Application Publication
(10) Pub. No.: US 2023/0081665 A1
(43) Pub. Date: Mar. 16, 2023

(54) PREDICTED COURSE DISPLAY DEVICE AND METHOD

(71) Applicant: Furuno Electric Co., Ltd., Nishinomiya (JP)

(72) Inventors: Masaya IZUMIKAWA, Nishinomiya (JP); Kazunari IMANAKA, Kawanishi (JP)

(21) Appl. No.: 17/901,669

(22) Filed: Sep. 1, 2022

(30) Foreign Application Priority Data
Sep. 10, 2021 (EP) 21196108.1

(51) Int. Cl. G01C 21/20; B63B 49/00; B63B 79/40; B63B 79/10

(52) U.S. Cl. CPC G01C 21/203; B63B 49/00; B63B 79/40; B63B 79/10

(57) ABSTRACT

A predicted course display device for a movable body includes an interface module to receive a planned route of the movable body, a position measurement module to detect a current position of the movable body, a geographical information selection module to determine geographic information of a region surrounding the movable body that is to be displayed on a display screen, a tidal current information reception module to receive tidal current information of the region surrounding the movable body, a course prediction module to predict a course of the movable body based on the tidal current information, and a course information generation module to generate display information for showing the planned route and the predicted course corresponding to a specific position on the display screen.

### CROSS-REFERENCE TO RELATED APPLICATION(S)

This application claims priority under 35 U.S.C. § 119 to European Patent Application No. 21196108.1, which was filed on Sep. 10, 2021, the entire disclosure of which is hereby incorporated by reference.

### TECHNICAL FIELD

The present disclosure mainly relates to a marine navigation system with augmented reality, and more specifically to a predicted course display device and method for navigation of a movable body on water using augmented reality.

### BACKGROUND

A conventional navigation system provides information regarding a planned route to be navigated by a marine vessel. Tides and other external disturbance factors, for example, wind, have been known to influence an actual course of the marine vessel on water, which results in deviation from the planned route. Vessel navigating personnel, for example, captain, crew, or other navigating personnel on-board the marine vessel may be unaware of difference between the actual course and the planned route. The vessel navigating personnel is required to continuously adjust the marine vessel based on a current location of the marine vessel and the influence of each tide on the actual course of the marine vessel. The continuous adjustment of the marine vessel by the vessel navigating personnel may result in accidents or collisions due to tiredness or carelessness of the vessel navigating personnel.

Various Augmented Reality (AR) based navigation systems have been developed in the past for assisting in the navigation of marine vessels. Traditionally, these systems have been depicting tidal information, for example, conditions associated with a tidal current at a predetermined position in relation to a current position of the marine vessel. Such geographical conditions when estimated can facilitate the vessel navigating personnel in monitoring operation of, and navigating, the marine vessel based on the influence of tides. For example, using the information pertaining to such geographical conditions, the vessel navigating personnel can steer the marine vessel i.e., by adjusting a heading direction of the marine vessel effectively and in a timely manner, if needed, so that the heading direction is, for instance, based on the direction of the tidal current. However, the vessel navigating personnel is required to continuously assume the effect of tides from the information and adjust the marine vessel.

Moreover, existing conventional Augmented Reality (AR) based navigation systems can display image information captured by an image sensor (camera) and information about surrounding ships and land acquired based on information captured by a sensor such as a radar. However, they are unable to provide the vessel navigating personnel with any visual information indicating the deviation of the actual course of the marine vessel from the planned route. Thus, the vessel navigating personnel is unable to navigate the ship properly on the planned route. For the aforementioned reasons, there is a need for providing a system and method that overcomes the problems of the conventional Augmented Reality (AR) based navigation systems and facilitates the vessel navigating personnel to navigate the marine vessel effectively.

### SUMMARY

In an embodiment of the present disclosure, there is provided a predicted course display device for a movable body. The predicted course display device includes an interface, and processing circuitry. The interface is configured to receive a planned route of the movable body. The processing circuitry is configured to detect a current position of the movable body, determine geographic information of a region surrounding the movable body. The geographic information is to be displayed on a display screen. The processing circuitry is configured to receive tidal current information of the region surrounding the movable body, from one of: an external communication equipment and one or more sensors attached to the movable body. The processing circuitry is configured to predict a course of the movable body based on the tidal current information. The processing circuitry is configured to generate display information for showing the planned route and the predicted course corresponding to a specific position on the display screen.

Additionally, or optionally, the processing circuitry is configured to generate the display information by superimposing the planned route and the predicted course corresponding to the specific position on the display screen.

In another aspect of the present disclosure, there is provided a predicted course display method. The predicted course display method includes, receiving a planned route of a movable body, detecting a current position of a movable body, determining geographic information of a region surrounding the movable body that is to be displayed on a display screen, receiving tidal current information of the region surrounding the movable body, from one of: an external communication equipment and one or more sensors attached to the movable body, predicting a course of the movable body based on the tidal current information, and generating display information for showing the planned route and the predicted course corresponding to a specific position on the display screen.

In yet another aspect of the present disclosure, there is provided a non-transitory computer readable medium having stored thereon computer-executable instructions which, when executed by a computer, cause the computer to receive a planned route of a movable body, detect a current position of a movable body, determine geographic information of a region surrounding the movable body that is to be displayed on a display screen, receive tidal current information of the region surrounding the movable body, from one of: an external communication equipment and one or more sensors attached to the movable body, predict a course of the movable body based on the tidal current information, and generate display information for showing the planned route and the predicted course corresponding to a specific position on the display screen.

The problem of not being able to display visual information that can be intuitively used by the vessel navigating personnel to navigate the ship properly on the planned route is solved by using a predicted course display device that depicts difference between the planned route and the predicted course of the marine vessel in relation to the current position of the ship, especially under the influence of tides and other external disturbance factors. Accordingly, the predicted course display device of the present disclosure offers to present the difference between the planned route and the predicted course of the marine vessel to the navigating personnel for use in a highly intuitive manner to navigate the ship properly on the planned route.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein:

FIG. 1 is a block diagram illustrating an entire configuration of a predicted course display device for a movable body in which an image sensor is attached to the movable body according to one embodiment of the present disclosure;

FIG. 2 illustrates a superimposed image of a region including the movable body and showing a planned route, a predicted course of the movable body, and a tidal arrow displayed on a display screen of the predicted course display device;

FIG. 3 illustrates an enlarged view of the superimposed image of FIG. 2 showing a tidal arrow displayed as a compass-based mark;

FIG. 4 illustrates a bird view image of the region including the movable body and showing the planned route, the predicted course and the tidal arrow; and

FIG. 5 is a flow chart illustrating a predicted course display method in accordance with an embodiment of the present disclosure.

### DETAILED DESCRIPTION

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

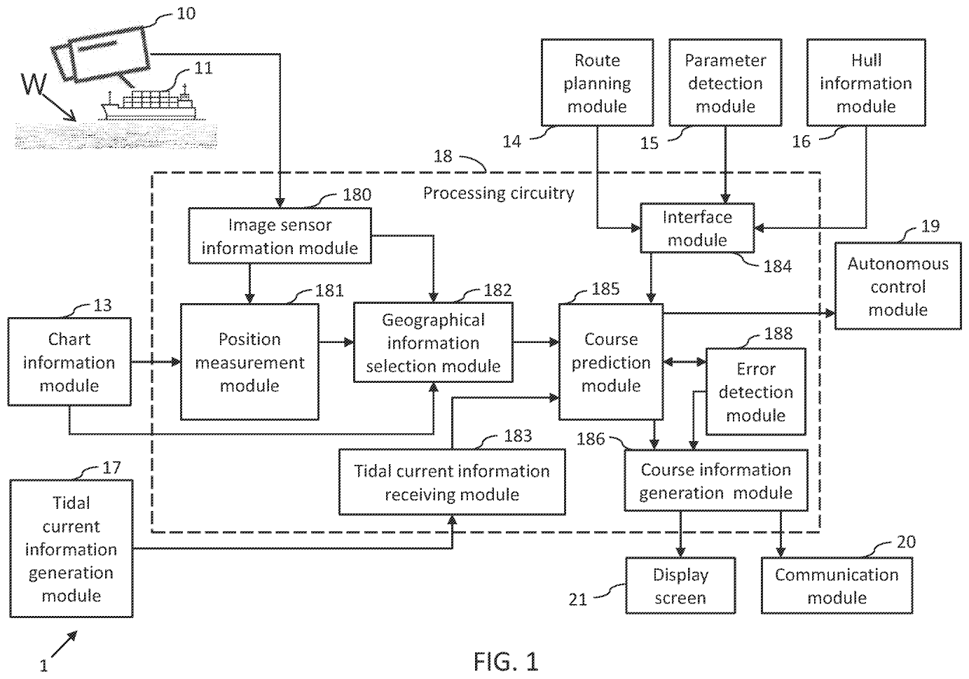

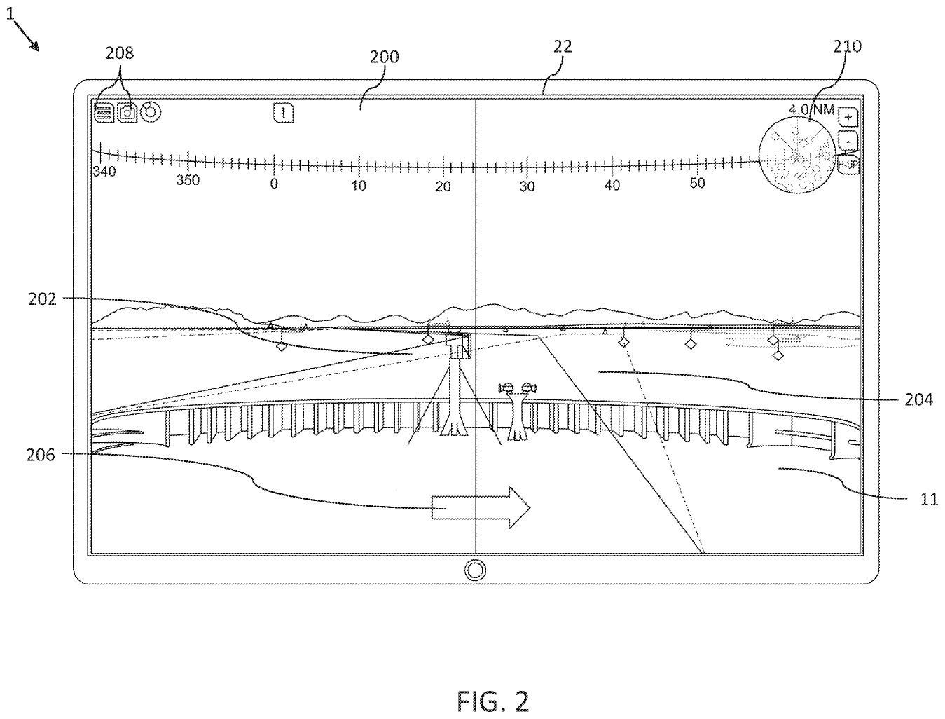

FIG. 1 is a block diagram illustrating an entire configuration of a predicted course display device 1 in which an image sensor 10 (hereinafter also referred to as a camera 10) is attached to a movable body 11 (hereinafter also referred to as a ship 11), according to one embodiment of the present disclosure. FIG. 2 illustrates a superimposed image 200 of a region including the movable body 11 and showing a planned route 202, a predicted course 204 of the movable body 11, and a tidal current information indicator 206 (hereinafter also referred to as a tidal arrow 206) indicating information associated with tidal currents.

Next, mainly referring to FIG. 1, the predicted course display device 1 includes the image sensor 10, a chart information module 13, a route planning module 14, a parameter detection module 15, a hull information module 16, a tidal current information generation module 17, processing circuitry 18, an autonomous control module 19, a communication module 20, and a display screen 21.

The predicted course display device 1 may be located on-board the ship 11 and provided with, or in electrical connection to, the camera 10 on the ship 11, as the ship instrument for purposes as will be explained in detail later herein.

The camera 10 may be configured as, for example, a limited-viewing angle or a wide-angle video camera which images a water surface W in the vicinity, or around at least a portion of the perimeter of the ship 11. This camera 10 may have a live output function, capable of generating video data (image data) as the imaged result in real time, and outputting it to the display screen 21. As illustrated in FIG. 1, the camera 10 may be installed in the ship 11 so that an imaging direction generally faces onto the water surface W forward of a hull of the ship 11.

The camera 10 may be attached to the ship 11 through a rotating mechanism (not illustrated) and, therefore, the imaging direction can be changed in a given angle range on the basis of the hull of the ship 11, for example, by inputting one or more commands via the predicted course display device 1 for instructing a panning/tilting of the camera 10.

The display screen 21 is configured to display the superimposed image 200 (hereinafter also referred to as an image 200) expressing the situation around the movable body 11 using Augmented Reality (AR) based on, among other things, a current position of the ship 11 as will be explained later herein, and superimposing the planned route 202 and the predicted course 204 of the movable body 11 on the image 200 along with the tidal current information indicator 206. The planned route 202 is a predetermined path to be followed by the ship 11 to navigate and reach a predetermined position. The predicted course 204 is a path on which the ship 11 is predicted to be moving forward.

The display screen 21 may be configured as, for example, a display screen that forms part of a navigation assisting device to which a ship operator, i.e., a user, who operates the ship 11 refers. However, the display screen 21 is not limited to the above configuration, and, for example, it may be a display screen for a portable computer which is carried by a ship operator's assistant who monitors the surrounding situation from the ship 11, a display screen for a passenger to watch in the cabin of the ship 11, or a display part for a head mounted display, such as a wearable glass, worn by a passenger.

Although, the camera 10, and the display screen 21 are shown to be an integral part of the predicted course display device 1, it would be apparent to one of ordinary skill in the art, that the camera 10, and the display screen 21 may be external to the predicted course display device 1. The camera 10, the display screen 21 and the predicted course display device 1 may integrally form an Augmented Reality (AR) based navigation apparatus that autonomously, or at least semi-autonomously facilitates a user to, navigate the ship 11 across the sea. The AR based navigation apparatus enables the user to navigate the ship 11 by superimposing the planned route 202 and the predicted course 204 of the ship 11, in real-time, on live images of surroundings of the ship 11 in a manner which is easy for a user to comprehend.

The predicted course display device 1 may also be operably coupled with variety of peripheral devices including, but not limited to, a keyboard and a mouse which the user may operate for performing various functions pursuant to functionalities in the present disclosure. For example, the user can provide various kinds of instructions to the AR based predicted course display device 1 and the camera 10 about generation of an image by operating the keyboard and/or the mouse. The instructions may include the pan/tilt operation of the camera 10, setting of displaying or not-displaying of various types of information, and a setup of a viewpoint from which the image is captured.

The chart information module 13 may be configured to receive and store the global geographical map, or another specified geographical map for a region, based on electronic nautical chart information that may be known beforehand to the chart information module 13.

The route planning module 14 is configured to generate and store a plurality of routes for navigation of the ship 11. In one embodiment, the user may operate the peripheral devices operably coupled with the predicted course display device 1 for performing various functions pursuant to functionalities in the present disclosure. For example, the user can provide various kinds of instructions to the AR based predicted course display device 1 about a source and a destination for navigation of the ship 11 by operating the keyboard and/or the mouse. Based on the information obtained from the user, such as the source and the destination, the route planning module 14 may generate and provide one or more routes for navigation of the ship 11 from the source to the destination. In one embodiment, each route may be associated with route information that may include, at least one of: date and time of travel, weather conditions, tidal conditions, and the like. The route planning module 14 receives a user input from the user regarding selection of a route as the planned route 202 for navigation of the ship 11 from the source to the destination. It will be apparent to person skilled in the art that although in the present embodiment, the user selects the route for travelling, in an alternate embodiment, an optimal route may be selected by the route planning module 14 based on current weather conditions, time of travel, tidal conditions, and the like.

The parameter detection module 15 is configured to detect various parameters of the movable body 11 such as the heading direction in which a nose of the ship 11 is pointed, a speed of the ship 11, and a rudder angle. Based on the detection of the various parameters of the ship 11, the parameter detection module 15 is further configured to generate heading information, speed information, and rudder angle information of the ship 11. The heading information indicates a compass direction, i.e., the heading direction in which the nose of the ship 11 is pointed. The speed information indicates the speed of the ship 11. In one embodiment, the speed information indicates the speed of the ship 11 in real-time. In another embodiment, the speed information indicates the speed of the ship 11 at pre-defined time intervals. The rudder angle information indicates the rudder angle, i.e., an angular position of a rudder blade of the ship 11.

The parameter detection module 15 may be operably coupled with, and hence in communication with, one or more sensors and/or indicators, such as a direction sensor, a speed indicator, and a rudder angle indicator, to generate the heading information, the speed information, and the rudder angle information. The hull information module 16 is configured to store hull information that includes at least one of: a breadth, a draft, a freeboard, a length at waterline, a length between perpendiculars, and an overall length of a hull of the ship 11.

The tidal current information generation module 17 is configured to generate tidal current information of a region surrounding the ship 11 such that the tidal current information including at least one of: a speed of a tide, a direction of the tide, and a position of the tide on the water surface W. The tidal current information generation module 17 may include an external communication equipment, for example, a land station, a Global Navigation Satellite System (GNSS) receiver, an Electronic Chart Display and Information System (ECDIS), an Automated Identification System (AIS) receiver, a radar device, or other peripheral devices that form part of the on-board ship equipment for detecting tides and/or measuring their pertinent tidal current information. In addition to the position of the tide, the tidal current information may further include a present speed and direction of the tide, or a speed and direction of the tide at an estimated (future) time, i.e., when the ship 11 is estimated to reach the predetermined position of the tide as will be evident from the appended disclosure.

With continued reference to FIG. 1, the processing circuitry 18 includes an image sensor information module 180, a position measurement module 181, a geographical information selection module 182, a tidal current information receiving module 183, an interface module 184, a course prediction module 185, a course information generation module 186, and an error detection module 188.

The image sensor information module 180 may be configured to receive an image captured by the image sensor 10, and output image data corresponding to the captured image to the display screen 21. Further, the image sensor information module 180 may also be configured to receive and store image sensor information including a position and an azimuthal orientation of the image sensor 10 with respect to a reference axis of a global geographical map. The image sensor 10 is installed on the ship 11. While capturing images (and for sake of clarity in this disclosure), a position of the image sensor 10 may be assumed to be deduced from, for example, the current position of the ship 11 in the map and the azimuthal orientation of the image sensor 10 may be assumed from, for example, a heading direction of the ship 11 with respect to a meridian plane.

The position measurement module 181 is configured to detect a current position of the ship 11. To do so, the position measurement module 181 may determine positional information of the ship 11. The position measurement module 181 is configured to detect the current position of the ship 11 via any external equipment, for example, a land station or an on-board sensing system such as, but not limited to, a Global Navigation Satellite System (GNSS) receiver, an Electronic Chart Display and Information System (ECDIS), an Automated Identification System (AIS) receiver, a radar device, a sonar etc.

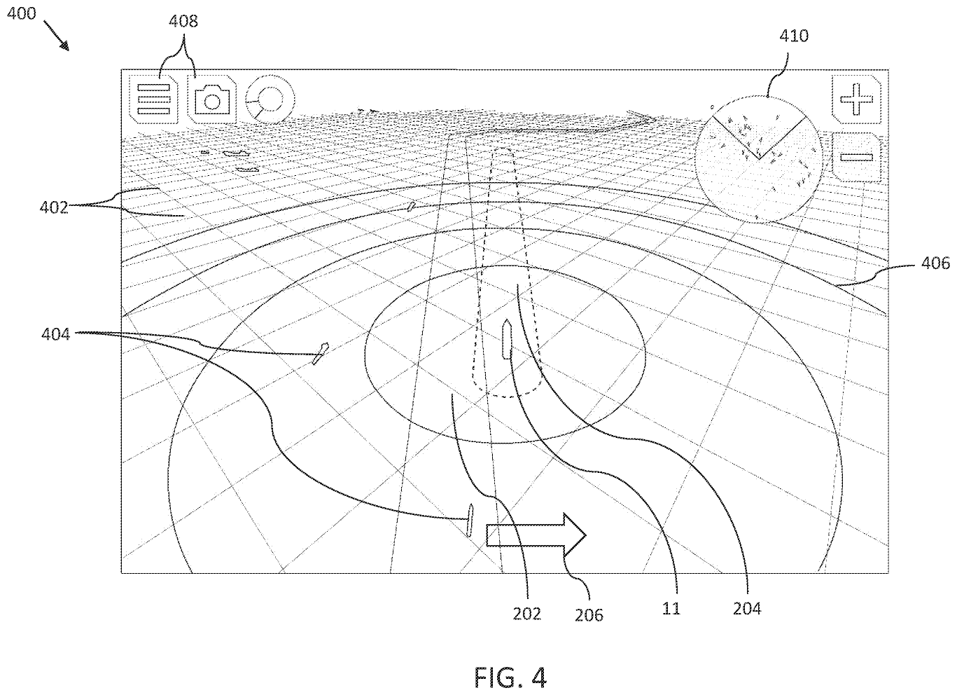

The geographical information selection module 182 is configured to determine geographic information of a region surrounding the ship 11. The geographic information is to be displayed on the display screen 21. In one embodiment, the geographic information may include the geographical map of the region surrounding the ship 11, or a geographical map of a region corresponding to a field of view of the image sensor 10. In another embodiment, the geographic information may include the image captured by the image sensor 10 that is attached to the ship 11. In one example, the geographic information selection module 182 is further configured to determine a bird view image (shown later in FIG. 4) of a region surrounding the ship 11. The bird view image may be generated by computer graphics based on the image captured by the image sensor 10 and information received from the external equipment, such as the AIS receiver or the radar device. The bird view image illustrates a three-dimensional view of the region surrounding the ship 11.

The tidal current information receiving module 183 is configured to receive and store the tidal current information of the region surrounding the ship 11. The tidal current information receiving module 183 may be disposed in communication with the tidal current information generation module 17, i.e., one of: the external communication equipment and one or more sensors attached to the ship 11, to receive the tidal current information based on the current position of the ship 11 detected by the position measurement module 181.

The interface module 184 is operably coupled with the route planning module 14, and configured to receive the route selected by the user as the planned route 202. The interface module 184 is further operably coupled with the parameter detection module 15 and the hull information module 16, and configured to receive at least one of: the heading information, the speed information, the rudder angle information, and the hull information of the ship 11.

The course prediction module 185 is operably coupled with the tidal current information receiving module 183, and configured to receive the tidal current information. The course prediction module 185 is configured to predict the course 204 of the movable body 11 based on the tidal current information. In one embodiment, the course prediction module 185 is further configured to predict the course 204 of the ship 11 based on the current position of the ship 11 received by the position measurement module 181.

The course prediction module 185 is further operably coupled with the interface module 184, and further configured to receive the planned route 202 and at least one of: the heading information, the speed information, the rudder angle information, and the hull information. In one embodiment, the course prediction module 185 is further configured to predict the course 204 of the ship 11 based on at least one of: the heading information, the speed information, the rudder angle information, and the hull information.

Referring to FIGS. 1 and 2 together, the course information generation module 186 is configured to generate display data for displaying the superimposed image 200 on the display screen 21 for displaying the planned route 202 and the predicted course 204 of the ship 11 corresponding to a specific position on the display screen 21. In one embodiment, as illustrated in FIG. 2, the planned route 202 is a path to be followed by the ship 11 to navigate and reach the destination. In this embodiment, the course information generation module 186 is configured to generate display information for displaying the planned route 202 on the display screen 21 when the planned route 202 is received from the user. In a further embodiment, the planned route 202 is received from the user when a user performs a click operation. The term ‘click operation’ disclosed herein may be performed by the user using a tactile interface on the display screen 21 of the predicted course display device 1, or alternatively, by use of other peripheral devices, for example, an input receiving module (not shown) such as a keyboard or a mouse that may be operably coupled with the predicted course display device 1. The user may request the predicted course display device 1 to select one route from the one or more routes between the source and the destination as the planned route 202 to be displayed in the image 200 obtained from the image sensor 10.

Additionally, referring to FIGS. 1 and 2 together, the course information generation module 186 is configured to generate the display information for displaying the predicted course 204 corresponding to the current position of the movable body 11 and at least one of: the heading information, the speed information, the rudder angle information, and the hull information on the display screen 21.

Additionally, in an embodiment, as illustrated in FIG. 2, the predicted course 204 is a path predicted by the course prediction module 185 on which the ship 11 will be moving forward based on the current position of the ship 11 and at least one of: the heading information, the speed information, the rudder angle information, and the hull information associated with the ship 11. In this embodiment, the course information generation module 186 is configured to generate the display information for displaying the predicted course 204 on the display screen 21 continuously or at predefined intervals.

Referring mainly to FIG. 1, in embodiments herein and also as best shown in the view of FIG. 2, the course information generation module 186 is generally configured to generate the display information for superimposing the planned route 202 and the predicted course 204 corresponding to the specific position on the display screen 21 and display the superimposed image 200 on the display screen 21.

In an embodiment, the specific position disclosed herein may be any reference position on the display screen 21, such as a position on the display screen 21 that display the ship 11. In another embodiment, the specific position may include a pre-set position, for example, a center of the display screen 21.

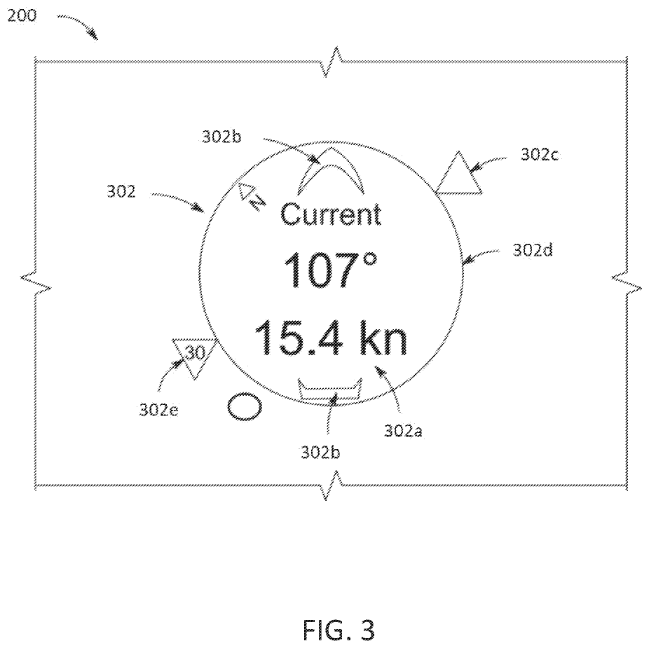

Furthermore, the course information generation module 186 is configured to generate the display information for showing the tidal current information indicator 206 for displaying on the display screen 21. In an embodiment, the tidal current information indicator is displayed as the tidal arrow. The tidal arrow 206 is displayed for indicating a direction of the tidal current, for example, an imminent/oncoming tide with respect to an estimated heading direction of the ship 11, indicated by the tidal current information. A length of the tidal arrow 206 displayed is based on a speed of the tidal current indicated by the tidal current information, for example, the length of the tidal arrow 206 increases or decreases proportionally with respect to increase or decrease in the speed of the tidal current. In an embodiment, the tidal current information indicator 206 is displayed as a compass-based mark having a direction panel as shown in FIG. 3. The direction panel indicates the direction of the tidal current obtained from the tidal current information.

Although it is disclosed herein that the tidal current information indicator 206 is used to depict the change in direction of the tide, or tidal current, encountered by the ship 11 currently, such a case is explanatory in nature and hence, non-limiting of this disclosure. In an alternative embodiment, the tidal current information indicator 206 may be indicative of an altogether different tide that is subsequent in position to a tide is being currently encountered by the ship 11. Accordingly, it will be acknowledged by persons skilled in the art that alternate interpretations for the specific meanings of each symbol herein, for instance, the tidal current information indicator 206 may be possible in lieu of that disclosed herein without deviating from the spirit of the present disclosure.

FIG. 3 illustrates an enlarged view of the superimposed image 200 showing the tidal arrow 206 displayed as the compass-based mark 302. The compass-based mark 302 is configured for showing a gauge 302a for including a speed and direction of the tidal current at the detected position of the movable body 11, i.e., when the moveable body 11 is directly above, or overhead with respect to, the tidal current, or stated differently, the tidal current is directly underneath the moveable body 11.

Further, the compass-based mark 302 may also be configured to show another ship-shaped symbol 302b for indicating an actual heading direction of the movable body 11. The terms “actual heading direction” used herein may be regarded as the current, or present, heading direction of the ship 11. Furthermore, the compass-based mark 302 may also be configured to show a first triangle-shaped indicator 302c, i.e., the direction panel, movable around a periphery 302d of the gauge 302a for dynamically indicating a direction of the tidal current with respect to the actual heading direction of the movable body 11.

The compass-based mark 302 may also be configured to show a second triangle-shaped indicator 302e fixed around the periphery 302d of the gauge 302a for indicating an estimated time, upon expiry of which, the direction of tidal current changes. By way of an example in FIG. 4, the second triangle-shaped indicator 302e is displaying a numeral ‘30’ indicating that a direction of the tide, or the tidal current, would change from that depicted by way of the first triangle-shaped indicator 302c to the direction depicted by the second triangle-shaped indicator 302e and such change in direction of the tide would occur in a period of 30 minutes from a present time. The numeral “30” shall be counted down at a predefined interval, for example, each minute. In one example, the predefined interval may be set by a user, such as to count down the numeral “30” every 30 seconds, 1 minute, 10 minutes, or such combination, for example, from 30 minutes to 10 minutes, the predefined interval shall be 10 minutes, and within 10 minutes, the predefined interval shall be 1 minute.

Although it is disclosed herein that the second triangle-shaped indicator 302e is used to depict the change in direction of the tide, or tidal current, and the concomitant time in which such change in direction is likely to occur, such a case is explanatory in nature and hence, non-limiting of this disclosure. In an alternative embodiment, the second triangle-shaped indicator 302e may be indicative of an altogether different tide that is subsequent in position to a tide is being currently encountered by the ship 11 i.e., as indicated by the first triangle-shaped indicator 302c. Accordingly, it will be acknowledged by persons skilled in the art that alternate interpretations for the specific meanings of each symbol herein, for instance, the second triangle-shaped indicator 302e may be possible in lieu of that disclosed herein without deviating from the spirit of the present disclosure.

With implementation of embodiments herein, the course information generation module 186 outputs the planned route 202, the predicted course 204, and the tidal current information indicator 206 to the display screen 21 for superimposing the planned route 202, the predicted course 204, and the tidal current information indicator 206 onto the image 200 that is captured by the image sensor 10 and for displaying the superimposed image 200 on the display screen 21 of the predicted course display device 1. This way, the predicted course display device 1 of the present disclosure can beneficially provide visual information about the difference between the planned route 202 and the predicted course 204 along with the tidal arrow 206 in a manner that is easy for a user to visualize and comprehend therefrom. The user can thus adjust the navigation of the ship 11 to reduce the difference between the planned route 202 and the predicted course 204 based on the tidal arrow 206.

In one embodiment, the course information generation module 186 generates the display information for showing the planned route 202 and the predicted course 204 corresponding to the image data outputted by the image sensor 10 that captures the image 200. The course information generation module 186 superimposes the image data and the display information to generate the superimposed image 200 based on AR, and generates display data for displaying the superimposed image 200 on the display screen 21 for AR based navigation.

In another embodiment, the course information generation module 186 outputs the planned route 202, the predicted course 204, and the tidal current information indicator 206 to the display screen 21 for superimposing the planned route 202, the predicted course 204, and the tidal current information indicator 206 onto another image that has a different viewpoint than the image 200. FIG. 4 illustrates a bird view image 400 of the region including the movable body and showing the planned route, the predicted course and the tidal arrow. The bird view image 400 is a three-dimensional image and presents the region surrounding the ship 11 from a different viewing angle. The bird view image 400 is generated by utilizing computer graphics. In one embodiment, the user provides an instruction to the predicted course display device 1 and the camera 10 about a setup of a viewpoint from which the image is captured by operating the keyboard and/or the mouse. In the embodiment, the interface module 184 is receives the viewpoint from the user, and the course information generation module 186 rotates the display information based on the viewpoint. The course information generation module 186 provides the display information to the display screen 21 for displaying an image, such as the bird view image 400, having the viewpoint received from the user.

The planned route 202, the predicted course 204, and the tidal arrow 206 are superimposed onto the bird view image 400 and the superimposed bird view image 400 is displayed on the display screen 21 of the predicted course display device 1. The bird view image 400 further includes grid lines 402 that represent a horizontal plane at the sea level, other ships 404 in the region surrounding the ship 11, and range circles 406 that enable the user to visualize and track a distance of the other ships 404 from the ship 11. The other ships 404 are displayed based on the information received from the external communication equipment, such as the AIS receiver and the radar device.

The display screen 21 further displays menus, such as menus 208 and 408 as shown in FIGS. 2 and 4, respectively, that may indicate various options selectable or readable by the user relating to the display information, such as the viewpoint. In one embodiment, the display screen 21 is an interactive display and the user may interact with the display screen 21 to change one or more parameters associated with the display information, such as changing the viewpoint. Furthermore, the display screen 21 displays an indicator, such as an indicator 210 and an indicator 410 as shown in FIGS. 2 and 4, respectively, that represents a top view of the region surrounding the ship 11 indicating range circles, other ships in the vicinity, and moving direction of the ship 11.

It will be understood by a person skilled in the art that display screen 21 may display the planned route 202 and the predicted course 204 having different visual characteristics, such as colors, line width, line type, and the like, such that the user is able to visualize the planned route 202 and the predicted course 204 distinctly and track the deviation between the planned route 202 and the predicted course 204.

Additionally, or optionally, the error detection module 188 is operably coupled with the course prediction module 185, and configured to receive the planned route 202 and the predicted course 204. The error detection module 188 is further configured to detect an error between the planned route 202 and the predicted course 204, and issue an alert when the detected error exceeds a predetermined threshold. The alert is issued by way of at least one of: a display notification on the display screen 21 and an audio notification on an audio equipment of the user. In one embodiment, the error detection module 188 issues the alert by way of the display notification, such as displaying a predetermined color flashes or blinks, or displaying a message on the display screen 21. In another embodiment, the error detection module 188 issues the alert by way of the audio notification, such as playing a predetermined tone, a siren, or an automated voice message, by way of the audio equipment, such as speakers, operably coupled with the predicted course display device 1. The alert is issued to notify the user that the predicted course 204 of the ship 11 is deviating from the planned route 202 and the user is required to adjust the course of the ship 11 to continue navigation on the planned route 202 to reach the destination or the predetermined position.

The autonomous control module 19 is configured to control the ship 11 autonomously. In an embodiment, when the detected error is within a predetermined range, i.e., the deviation between the planned route 202 and the predicted course 204 is significantly small, the course prediction module 185 is further configured to trigger the autonomous control module 19 to control the ship 11 autonomously. In another embodiment, when the detected error is out of the predetermined range, i.e., the deviation between the planned route 202 and the predicted course 204 is significantly high, the course prediction module 185 is further configured to stop the autonomous control module 19 to control the ship 11 autonomously. The autonomous control module 19 may control the ship 11 by navigating the ship 11 based on at least one of: the tidal current information, the heading information, the speed information, the rudder angle information, and the hull information of the ship 11 to reduce the deviation between the planned route 202 and the predicted course 204 of the ship 11.

In an embodiment, the course information generation module 186 is further configured to generate the display information for showing one or more segments of the planned route 202 such that each segment corresponds to a path between two predetermined positions on the planned route 202. The predetermined positions may be the way-points on the planned route 202. In the embodiment, the course prediction module 185 may predict one or more segments of the course 204 corresponding to the one or more segments of the planned route 202, and the error detection module 188 calculates an error between respective segments of the planned route 202 and the predicted course 204. Further, the course information generation module 186 may be configured to generate the display information for showing the respective segments of the planned route 202 and the predicted course 204 on the display screen 21.

Additionally, or optionally, the communication module 20 is configured to receive the display information from the course information generation module 186 and transmit the display information to one or more external devices, for example, a smartphone, a tablet, or the like, to mirror the display shown on the display screen 21 on the one or more external devices. In one embodiment, the communication module 20 transmits the display information to a display screen for a portable computer which is carried by a ship operator's assistant who monitors the surrounding situation from the ship 11, a display screen for a passenger to watch in the cabin of the ship 11, or a display part for a head mounted display, such as a wearable glass, worn by a passenger, for showing the planned route 202 and the predicted course 204 corresponding to the specific position.

In the context of the present disclosure, the processing circuitry 18 includes a processor, computer, microcontroller, or other circuitry that controls the operations of various components such as an operation panel, and a memory. The processing circuitry 18 may execute software, firmware, and/or other instructions, for example, that are stored on a volatile or non-volatile memory, or otherwise provided to the processing circuitry 18.

A scope of the on-board ship equipment (information source for the position measurement module 181 and/or the geographical information selection module 182) of the predicted course display device 1 is not limited to any of the configurations that have been disclosed herein, and other types of instruments may be included to form part of the on-board ship equipment without limiting the scope of the present disclosure.

Further, the present disclosure is applicable not only to the ship which travels on the sea, but may also be applicable to arbitrary water-surface movable bodies which can travel, for example, on a lake, or a river.

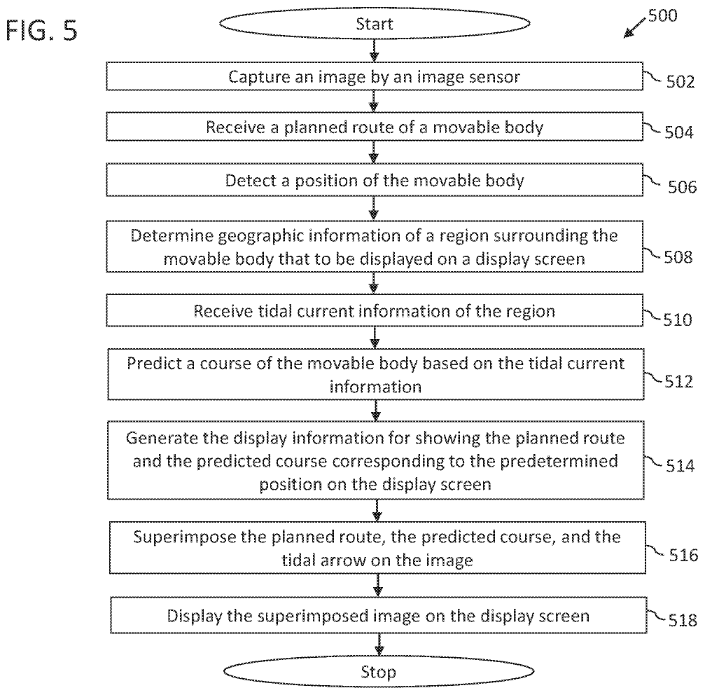

FIG. 5 is a flowchart illustrating a predicted course display method 500 in accordance with an embodiment of the present disclosure.

At step 502, the image sensor 10 is configured to capture the image 200, and output image data.

At step 504, the interface module 184 is configured to receive the planned route 202 from the user.

At step 506, the position measurement module 181 is configured to detect the position of the movable body 11.

At step 508, the geographical information selection module 182 is configured to determine the geographic information of the region surrounding the ship 11 that is to be displayed on the display screen 21.

At step 510, the tidal current information receiving module 183 is configured to receive the tidal current information of the region surrounding the ship 11, from one of: the external communication equipment and one or more sensors attached to the movable body 11.

At step 512, the course prediction module 185 is configured to predict the course 204 of the movable body 11 based on the tidal current information.

At step 514, the course information generation module 186 is configured to generate the display information for showing the planned route 202 and the predicted course 204 corresponding to the specific position on the display screen 21.

At step 516, the course information generation module 186 is further configured to superimpose the planned route 202, the predicted course 204, and the tidal current information indicator 206 on the image 200.

At step 518, the course information generation module 186 is configured to generate the display information for displaying the superimposed image 200 on the display screen 21.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A predicted course display device for a movable body, comprising:
an interface configured to receive a planned route of the movable body; and
processing circuitry configured to:
detect a current position of the movable body;
determine geographic information of a region surrounding the movable body, wherein the geographic information is to be displayed on a display screen;
receive tidal current information of the region surrounding the movable body, from one of: an external communication equipment and one or more sensors attached to the movable body;
predict a course of the movable body based on the tidal current information; and
generate display information for showing the planned route and the predicted course corresponding to a specific position on the display screen.

2. The predicted course display device of claim 1, wherein
the processing circuitry is further configured to predict the course of the movable body based on the current position of the movable body.

3. The predicted course display device of claim 1, wherein
the processing circuitry is further configured to
receive at least one of: heading information, speed information, rudder angle information, and hull information of the movable body; and
predict the course of the movable body based on at least one of: the heading information, the speed information, the rudder angle information, and the hull information.

4. The predicted course display device of claim 1, wherein:
the processing circuitry is configured to generate the display information by superimposing the planned route and the predicted course corresponding to the specific position on the display screen.

5. The predicted course display device of claim 1, further comprising:
a transmitter configured to transmit the display information to one or more external devices.

6. The predicted course display device of claim 4, further comprising:
a transmitter configured to transmit the display information to one or more external devices.

7. The predicted course display device of claim 1, wherein:
the processing circuitry is further configured to detect an error between the planned route and the predicted course, and issue an alert when the detected error exceeds a predetermined threshold.

8. The predicted course display device of claim 4, wherein:
the processing circuitry is further configured to detect an error between the planned route and the predicted course, and issue an alert when the detected error exceeds a predetermined threshold.

9. The predicted course display device of claim 1, further comprising:
an autonomous controller configured to control the movable body autonomously; wherein:
the processing circuitry is further configured to trigger the autonomous controller to control the movable body autonomously when the detected error is within a predetermined range.

10. The predicted course display device of claim 4, further comprising:
an autonomous controller configured to control the movable body autonomously; wherein:
the processing circuitry is further configured to trigger the autonomous controller to control the movable body autonomously when the detected error is within a predetermined range.

11. The predicted course display device of claim 1, wherein:
the processing circuitry is further configured to generate the display information for showing a tidal current information indicator showing a direction indicated by the tidal current information.

12. The predicted course display device of claim 4, wherein:
the processing circuitry is further configured to generate the display information for showing a tidal current information indicator showing a direction indicated by the tidal current information.

13. The predicted course display device of claim 11, wherein:
the tidal current information indicator includes a tidal arrow to indicate a direction of tide; and a length of the tidal arrow displayed is based on a speed of corresponding tidal current information.

14. The predicted course display device of claim 11, wherein:
the tidal current information indicator is displayed as a compass-based mark having a direction panel.

15. The predicted course display device of claim 1, wherein:
the processing circuitry is further configured to generate the display information for showing one or more segments of the planned route.

16. The predicted course display device of claims 1 wherein:
the interface is further configured to receive a viewpoint from a user, wherein:
the processing circuitry is further configured to rotate the display information based on the viewpoint.

17. The predicted course display device of claim 4 wherein:
the interface is further configured to receive a viewpoint from a user, wherein:
the processing circuitry is further configured to rotate the display information based on the viewpoint.

18. The predicted course display device of claim 1, further comprising:
an image sensor attached onto the movable body, and configured to capture an image, and output image data, wherein:
the processing circuitry is further configured to:
generate display information for showing the planned route and the predicted course corresponding to the image data;
superimpose the image data and the display information to generate a superimposed image based on augmented reality; and
generate display data for displaying the superimposed image on the display screen.

19. A predicted course display method, comprising:
receiving a planned route of a movable body;
detecting a current position of the movable body;
determining geographic information of a region surrounding the movable body, wherein the geographic information is to be displayed on a display screen;
receiving tidal current information of the region surrounding the movable body, from one of: an external communication equipment and one or more sensors attached to the movable body;
predicting a course of the movable body based on the tidal current information; and
generating display information for showing the planned route and the predicted course corresponding to a specific position on the display screen.

20. A non-transitory computer readable medium having stored thereon computer-executable instructions which, when executed by a computer, cause the computer to:
receive a planned route of a movable body;
detect a current position of the movable body;
determine geographic information of a region surrounding the movable body, wherein the geographic information is to be displayed on a display screen;
receive tidal current information of the region surrounding the movable body, from one of: an external communication equipment and one or more sensors attached to the movable body;
predict a course of the movable body based on the tidal current information; and
generate display information for showing the planned route and the predicted course corresponding to a specific position on the display screen.
